(19) United States
(12) Patent Application Publication
(10) Pub. No.: US 2009/0032170 A1
(43) Pub. Date: Feb. 5, 2009

(54) APPARATUS, TOOLS AND METHODS FOR CONNECTING NON-SOLVENT WELDABLE TUBING TO SOLVENT WELDABLE TUBING AND FITTINGS

(76) Inventor: Robert M. Williams, Longboat Key, FL (US)

Correspondence Address: MYERS BIGEL SIBLEY & SAJOVEC, PO BOX 37428, RALEIGH, NC, 27627, US

(21) Appl. No.: 11/867,402

(22) Filed: Oct. 4, 2007

Related U.S. Application Data
(60) Provisional application No. 60/952,707, filed on Jul. 30, 2007.

(51) Int. Cl. B32B 7/08; B25B 33/00; F16L 25/06

(52) U.S. Cl. 156/91; 285/328; 81/487

(57) ABSTRACT

A method for forming a connection includes: mounting an adapter on a non-solvent weldable tubing; and solvent welding the adapter to a solvent weldable member to form a connection between the non-solvent weldable tubing and the solvent weldable member.

### RELATED APPLICATION(S)

The present application claims the benefit of and priority from U.S. Provisional Patent Application Ser. No. 60/952,707, filed Jul. 30, 2007, the disclosure of which is hereby incorporated herein by reference in its entirety.

### BACKGROUND

Recently, non-solvent weldable polymeric tubing such as polyolefin tubing (e.g., polybutylene (PB) tubing, cross-linked polyethylene (PEX) tubing and polyethylene raised temperature (PE-RT) tubing) have been increasingly employed for certain plumbing applications, such as hot and cold water distribution systems. Because these tubings are non-solvent weldable, they tend to require flow restricting insert fittings and/or more expensive mechanical fittings than traditionally required for use with solvent weldable tubing.

### SUMMARY

According to embodiments of the present invention, a method for forming a connection includes: mounting an adapter on a non-solvent weldable tubing; and solvent welding the adapter to a solvent weldable member to form a connection between the non-solvent weldable tubing and the solvent weldable member.

According to embodiments of the present invention, an adapter for forming a connection between a non-solvent weldable tubing and a solvent weldable member includes a solvent weldable body, a gripper member and a resilient seal member. The gripper member is mounted on the body. The gripper member is configured to engage and mechanically secure the non-solvent weldable tubing to the adapter. The resilient seal member is configured to engage and form a fluid-tight seal between the non-solvent weldable tubing and the adapter.

According to further embodiments of the present invention, an installation tool is provided for use with an adapter for forming a connection between a non-solvent weldable tubing and a solvent weldable member, the adapter including a solvent weldable body and a gripper member mounted on the body, the gripper member including a plurality of teeth configured to engage and mechanically secure the non-solvent weldable tubing to the adapter. The tool includes a receiver portion defining a receiver cavity and a ledge in the receiver cavity. The ledge is configured to limit insertion of the adapter into the receiver cavity. A plurality of slots are defined in the ledge. The slots are configured to receive the teeth of the gripper member when the teeth are deflected by insertion of the non-solvent weldable tubing into the adapter when the adapter is mounted in the receiver cavity.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of an adapter according to embodiments of the present invention.

FIG. 2 is an exploded perspective view of the adapter of FIG. 1.

FIG. 3 is a cross-sectional view of the adapter of FIG. 1 taken along the line 3-3 of FIG. 1.

FIG. 4 is a cross-sectional view of a tubing assembly according to embodiments of the present invention including the adapter of FIG. 1 mounted on a non-solvent weldable tubing.

FIG. 5 is a perspective view of a connection assembly according to embodiments of the present invention and including the adapter of FIG. 1.

FIG. 6 is a perspective, cross-sectional view of the connection assembly of FIG. 5.

FIG. 7 is a top plan view of an installation tool according to embodiments of the present invention.

FIG. 8 is an enlarged, fragmentary, top view of the installation tool of FIG. 7.

FIG. 9 is a fragmentary, cross-sectional view of the installation tool of FIG. 7 and the adapter of FIG. 1.

FIG. 10 is a fragmentary, cross-sectional view of the installation tool of FIG. 7 and the adapter of FIG. 1 wherein the adapter is mounted in the installation tool.

FIG. 11 is a fragmentary, cross-sectional view of the installation tool of FIG. 7, the adapter of FIG. 1, and the non-solvent weldable tubing of FIG. 4 wherein the adapter is mounted in the installation tool and the non-solvent weldable tubing is mounted in the adapter.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant alit and will not be interpreted in an idealized or overly formal sense unless expressly so defined herein.

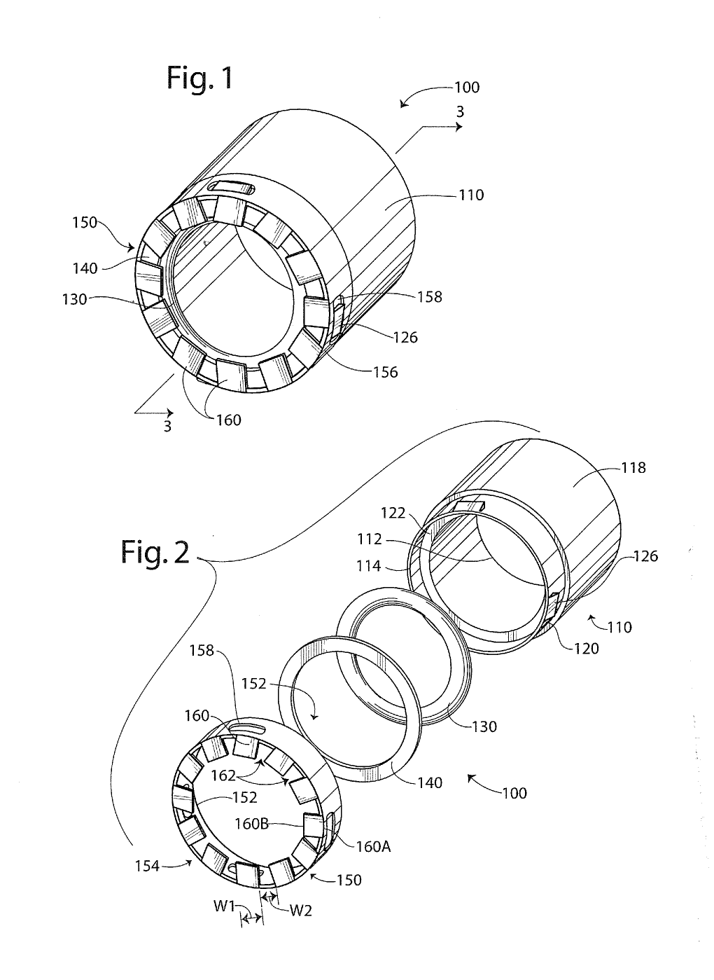

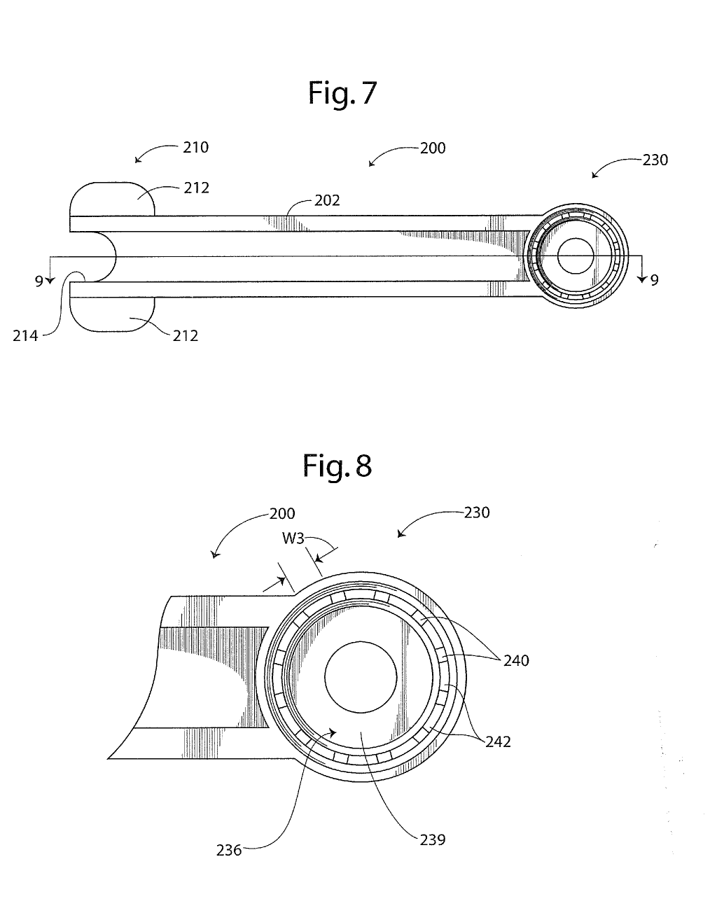

With reference to FIGS. 1-3, a transition fitting, bushing or adapter 100 according to embodiments of the present invention is shown therein. According to some embodiments, the adapter 100 is used to effectively and operatively couple a non-solvent weldable tubing to a solvent weldable tubing or fixture. For example, with reference to FIGS. 4-6, the adapter 100 may be used to join a non-solvent weldable tubing 20 to a solvent weldable member 30 using a solvent weld material to form a connection assembly 10. The adapter 100 may be installed and the connection 10 may be assembled using a tool 200 (FIGS. 7-11) according to embodiments of the present invention, for example.

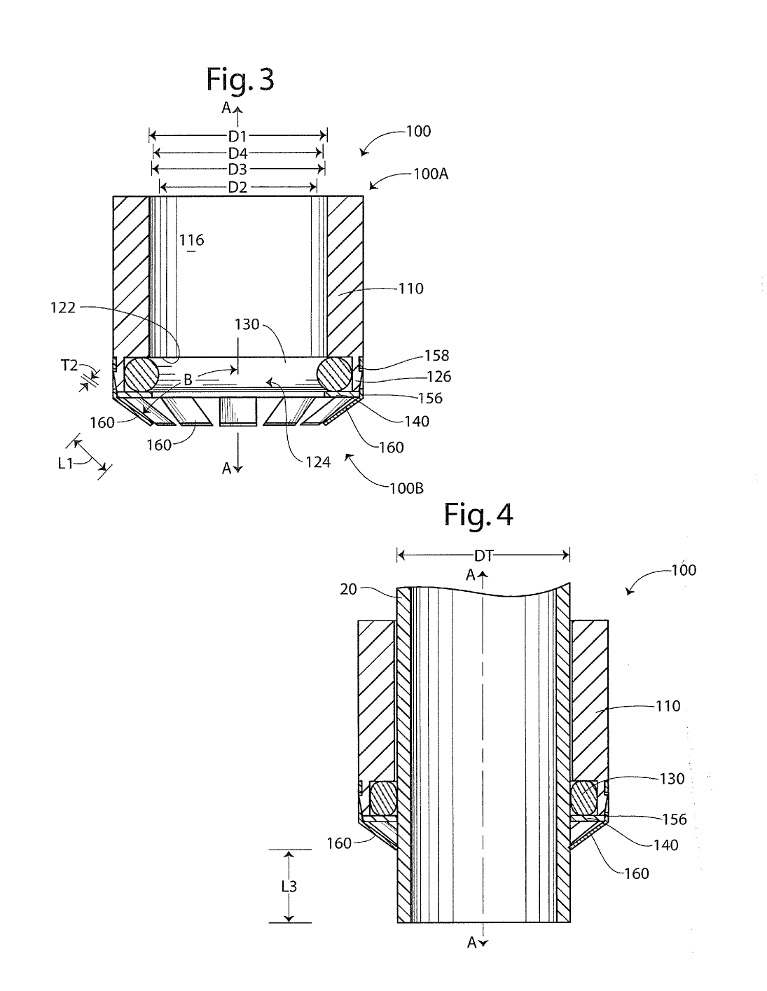

Turning to the adapter 100 in more detail, the adapter 100 has a first end 100A (referred to herein as the entrance end) and a second end 100B (referred to herein as the exit end) FIG. 3. The adapter 100 includes an annular body member 110, an annular seal member 130, an annular support spacer 140, and an annular gripper member 150.

With reference to FIGS. 2 and 3, the body 110 includes a cylindrical main section 118 and an annular end flange 120 defining an entry opening 112, an exit opening 114, and a through passage 116 extending from the entry opening 112 to the exit opening 114. A ledge 122 is located between the main section 118 and the flange 120. The ledge 122 and the flange 120 together define a recess or pocket groove 124. Four circumferentially spaced apart mounting tabs 126 extend radially outwardly from the flange 120. The body 110 defines a central insertion axis A-A extending through the openings 112, 114 and the passage 116.

The body member 110 may be formed of any suitable solvent weldable plastic or polymeric material. According to some embodiments, the body member 110 is formed of PVC and/or CPVC.

According to some embodiments, the nominal inner diameter D1 (FIG. 3) of the passage 116 in the main section 118 is greater than the outer diameter DT (FIG. 4) of the tubing 20. According to some embodiments, the diameter D1 is between about 0.005 and 0.015 inch greater than the outer diameter DT of the tubing 20. According to some embodiments, the diameter D1 is in the range of from about 0.630 to 0.640 inch.

The seal member 130 may be formed of any suitable sealing material. According to some embodiments, the seal member 130 is formed of an elastomeric material. According to some embodiments, the seal member 130 is formed of synthetic elastomer. According to some embodiments and as shown, the seal member 130 is an O-ring. According to some embodiments, the sealant member 130 is elastically deformable and has an inner diameter D2 (FIG. 3) less than the outer diameter DT of the tubing 20. According to some embodiments, the diameter D2 is between about 0.010 and 0.016 inch less than the outer diameter DT of the tubing 20. According to some embodiments, the diameter D2 is between about 0.609 and 0.615 inch.

The spacer 140 (FIGS. 4A and 4B) may be formed of any suitably rigid material. According to some embodiments, the spacer 140 is formed of a corrosion resistant material. According to some embodiments, the spacer 140 is formed of metal, and, according to some embodiments, a corrosion resistant metal. According to some embodiments, the spacer 140 is a stainless steel washer. According to some embodiments, the spacer 140 is stamped from metal. According to some embodiments, the inner diameter D3 (FIG. 3) of the spacer 140 is greater than the outer diameter DT of the tubing 20. According to some embodiments, the diameter D3 is between about 0.011 and 0.021 inch greater than the outer diameter of the tubing 20. According to some embodiments, the inner diameter D3 is in the range of from about 0.636 to 0.646 inch. According to some embodiments, the thickness T1 of the spacer 140 is in the range of from about 0.020 to 0.040 inch.

With reference to FIGS. 1-3, the gripper member 150 includes a collar or base section 156 and integral teeth 160 delectably cantilevered from the exit edge of the base section 156. The gripper member 150 has an entrance opening 152 and an exit opening 154. Each tooth 160 has a pivot end 160A adjoined to the base section 156 and an opposed bite or free end 160B. The teeth 160 define slots 162 therebetween. The teeth 160 are angled and collectively tapered to define a frusto-cone having a reduced diameter D4 at the exit end 100B. Four circumferentially spaced apart mounting slots 158 are defined in the base section 156.

The gripper member 150 may be integrally formed of any suitable strong, flexible, resilient material. According to some embodiments, the gripper member 150 is formed of a corrosion resistant material. According to some embodiments, the gripper member 150 is formed from metal and, according to some embodiments, a corrosion resistant metal. According to some embodiments, the gripper member 150 is formed of stainless steel. According to some embodiments, the gripper member 150 is stamped from metal. According to some embodiments, the base section 156 and the teeth have a thickness T2 (FIG. 3) in the range of from about 0.010 to 0.020 inch.

According to some embodiments, the inner diameter D4 (FIG. 3) defined by the teeth 160 (prior to installation of the tubing 20) is less than the outer diameter DT of the tubing 20. According to some embodiments, the diameter D4 is from about 0.010 to 0.025 less than the outer diameter of the tubing 20. According to some embodiments, the diameter D4 is in the range of from about 0.600 to 0.615 inch.

According to some embodiments, the teeth 160 have a length L1 (FIG. 3) in the range of from about 0.140 to 0.150 inch. According to some embodiments, the width W1 (FIG. 2) of each tooth 160 is in the range of from about 0.095 to 0.100 inch. According to some embodiments, the spacing width W2 (FIG. 2) between adjacent teeth 160 is in the range of from about 0.120 to 0.128 inch.

According to some embodiments, each tooth 160 extends (prior to installation of the tubing 20) at an angle B (FIG. 3) of between about 58 and 62 degrees with respect to the central axis A-A.

The adapter 100 is configured or assembled as follows. The seal member 130 is received in the pocket groove 124 of the body 110. The support spacer 140 is placed over the seal member 130. The gripper member 150 is in turn pressed or mounted over the end of the body 110 so that the seal member 130 and the spacer 140 are captured between the gripper member 150 and a ledge 122 of the body 110. The gripper member 150 is secured to the body 110 by interlock between the tabs 126 of the body 110 and the slots 158. The spacer 140 seats in the gripper member 150 such that the spacer 140 abuts the bases of the teeth 160. The spacer 140 may be biased against the teeth 160 by the seal member 130. The spacer 140 may serve to protect the seal member 130 from the gripper member 150 during assembly of the adapter 100. As discussed herein, the spacer 140 may also serve to assist in inhibiting or preventing withdrawal of the tubing 20 from the adapter 100.

With reference to FIGS. 7-9, the tool 200 includes a body 202 having an assembly press structure 210 on one end 200A and an adapter installation structure 230 on the opposite end 200B. According to some embodiments, the tool 200 is formed (e.g., by molding) from a non-solvent weldable polymer, such as a polyolefin.

The structure 210 includes a pair of opposed tabs 212 and a U-shaped slot 214.

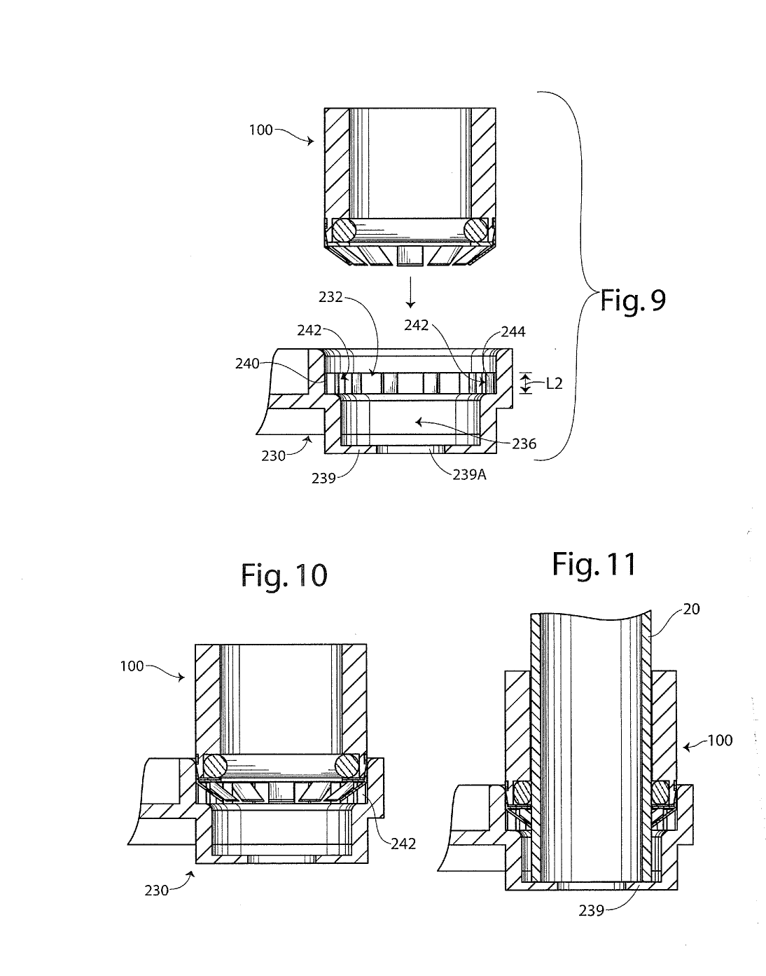

With reference to FIGS. 8 and 9, the structure 230 defines an entry opening 232, a passage 236 communicating with the opening 232, and a plurality of circumferentially spaced apart teeth 240. The teeth 240 define slots 242 therebetween. The teeth 240 generally form an annular ledge 244. The structure 230 also includes a bottom or floor wall 239 having a vent opening 239A therein.

According to some embodiments, the width W3 (FIG. 8) of each slot 242 is between about 0.060 and 0.065 inch greater than the width W1 (FIG. 2) of each tooth 160. According to some embodiments, each slot 242 has a depth L2 (FIG. 9) of between about 0.130 and 0.140 inch.

The tubing 20 may be any suitable non-solvent weldable plastic or polymeric tubing. According to some embodiments, the tubing 20 is formed of a high temperature polyolefin. According to some embodiments, the tubing 20 is formed of polybutylene, polyethylene, PEX, and/or polyethylene-raised temperature (PE-RT).

The solvent weldable member 30 may be formed of any suitable solvent weldable plastic or polymeric material. Suitable materials may include PVC and/or CPVC. The solvent weldable member may be of any suitable configuration. According to some embodiments, the solvent weldable member 30 is a solvent weldable fitting (such as a tubular fitting as shown) or solvent weldable tubing. According to some embodiments and with reference to FIG. 6, the solvent weldable member 30 has an opening 32 communicating with a passage 34, and an inner surface 36 along the passage 34.

The adapter 100 may be used as follows to form the connection 10. The adapter 100 is inserted into the tool structure 230 as shown in FIGS. 9 and 10 such that the shoulder of the gripper member 150 abuts the ledge 244 formed by the teeth 240 such that the teeth 160 are received in respective ones of the slots 242. The tubing 20 is then inserted through and beyond the adapter passage 116 until the lead end of the tubing 20 abuts the floor 239 as shown in FIG. 11. The slots 242 permit the teeth 160 to flex radially outwardly unencumbered as the tubing 20 is inserted with the gripper member 150 supported by the ledge 244, thereby reducing the insertion force required as well as reducing the risk of scoring of the tubing outer surface. The tool structure 230 can ensure that the tubing 20 is inserted fully enough that the gripper member 150 is fully engaged and the seal with the seal member 130 is properly effected, but not so far that the tubing 20 would create a flow obstruction once the connection 10 is formed.

According to some embodiments, the ledge 244 and the floor 239 of the tool 200 are relatively spaced apart such that the tubing 20 is overinserted through (i.e., the free end extends beyond) the adapter 100 a prescribed distance or length L3 (FIG. 4). According to some embodiments, the length L3 is in the range of from about 0.300 to 0.330 inch.

The tubing 20 with the adapter 100 now installed thereon is then removed from the tool 200 as shown in FIG. 4. The weld solvent is applied to the outer surface 111 of the body member 110 and to the inner surface 36 of the fitting 30. The weld solvent is adapted to temporarily soften the material of each component so that the components melt, intermingled, and re-solidify into an integral, welded unit. The weld solvent may be any suitable weld solvent adapted to chemically weld two solvent weldable polymeric components. According to some embodiments, the weld solvent is a blend of solvents. Suitable weld solvents may include, for example, tetrahydrofuran and cyclohexanone.

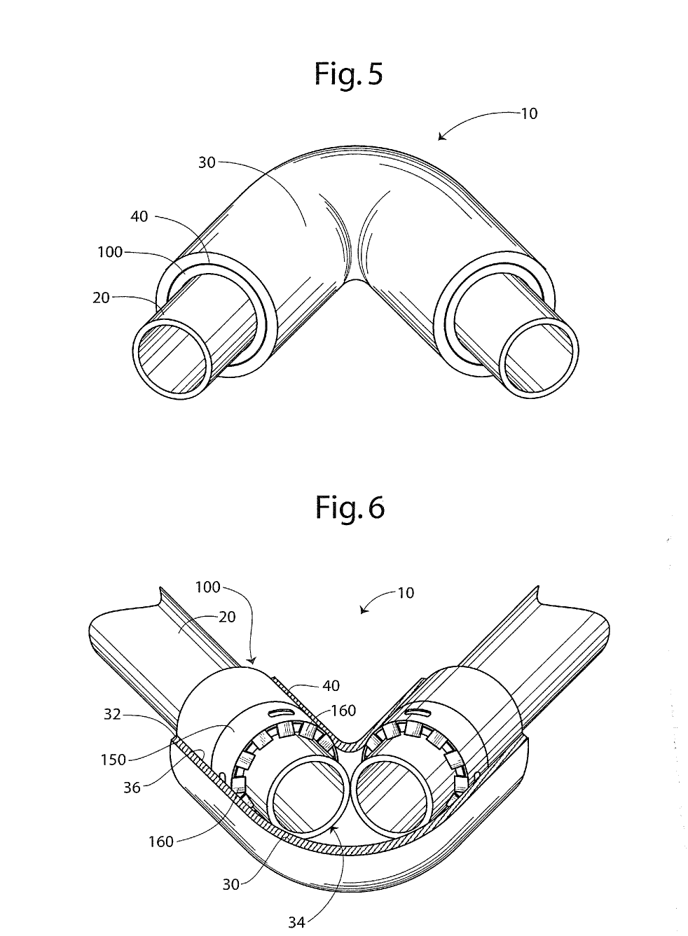

The adapter 100 (with the tubing 20 installed therein) is then inserted into the passage 34 of the fitting 30 through the opening 32 until the entrance end 100A of the body 110 is approximately flush with the opening 32 as shown in FIGS. 5 and 6. The tool structure 210 (FIG. 7) may be used to facilitate insertion. More particularly, the tubing 20 is placed in the slot 214 and the user presses against the tabs 212 to push the body member 110 into position in the passage 34. In this manner, the tool 200 can assist the installer in inserting the adapter 100 into the socket of the fitting 30 without altering the position of the adapter 100 on the tubing 20 (e.g., as may occur if the installer attempted to insert the adapter 100 by pushing on the tubing 20). The weld solvent will then weld the body member 110 to the fitting 30 as described above to form a secure weld 40 (FIG. 6).

The adapter 100 and the foregoing method can provide a mechanically secure, fluid sealed coupling. The coupling between the body member 110 and the fitting 30 is accomplished by solvent welding of two solvent weldable materials to provide an effective mechanical and fluid tight coupling as is well known to those of skill in the art. The seal member 130 provides a fluid tight seal between the adapter 100 and the tubing 20 (more particularly, between the inner surface of the body member 110 and the outer surface 22 of the tubing 20). The gripper member 150 provides a mechanical interlock between the adapter 100 and the tubing 20 to permanently prevent withdrawal of the tubing 20 from the adapter 100 in the reverse direction beyond the seal member 130. More particularly, the teeth 160 engage the outer surface 22 of the tubing 20 at an angle with respect to the axis of the tubing 20 such that attempted withdrawal of the tubing 20 causes the teeth 160 to bite into or wedge against the outer surface 22.

The adapter 100 thus takes advantage of the geometrical configuration of the assembly, and in particular of the teeth 160 and the tubing 20, to ensure a secure hold. The spacer 140 serves to preserve this geometrical advantage by preventing the teeth 160 from deflecting toward the entrance end 100A beyond 90 degrees (with respect to the tubing insertion axis). The spacer 140 thereby functions as a support member to prevent the teeth 160 from inverting (which, if permitted, may release the bite of the teeth 160 on the tubing 20 and permit withdrawal of the tubing 20). The spacer 140 may ensure that the mechanical coupling between the tubing 20 and the adapter 100 (in particular, the gripper member 150) is effectively permanent in service. The spacer 140 can therefore permit the use of a thinner and/or more flexible material for the gripper member 150. According to some embodiments, the spacer 140 is configured and positioned such that the spacer 140 only supports the teeth 160 (i.e., limits their deflection) when the teeth 160 are inwardly deflected by partial withdrawal of the tubing 20.

In the foregoing manner, the adapter 100 and method can provide a connection 10 that is sufficiently permanent that it can meet existing code requirements for non-accessible fitting joints and therefore can be utilized behind walls and in enclosed spaces without requiring special market preparation and/or code acceptance procedures. The adapter 100 does not present additional bulkiness to the connection 10 as may be the case with traditional mechanical and compression transition and joining type fittings. Adapters and methods according to embodiments of the present invention can provide a low cost transition between existing solvent weld plastic fittings and non-solvent weldable polymeric tubing and/or pipe.

The adapter 100 can be installed without special tools or calibration. Unlike some insert fitting systems, the connection 10 may cause little or no significant reduction in water flow through the tubing. By contrast, known mechanical, compression and insert fittings (e.g., of the type utilizing metal rings that are crimped in place using a special tool) commonly used to couple non-solvent weldable tubing may substantially reduce water flow.

According to some embodiments, the adapter 100 is factory assembled. According to some embodiments, a kit is provided including a plurality of the adapters 200 packaged in combination with the tool 200.

Adapters and methods of the present invention may provide for easy field assembly. The construction of the adapter 100 permits factory assembly such that no field assembly of the adapter 100 is required.

Because the seal member 130 is mounted upstream or inboard of the gripper member 150, the installer is guaranteed that the tubing 20 has passed fully through the seal member 130 if the tubing 20 engages the teeth 160.

According to some embodiments, the adapter 100 and the connection 10 form a part of a hot and cold water supply system. According to some embodiments, the adapter 100 and the connection 10 form a part of a radiant heating system including a network or loop of tubing through which hot fluid is circulated.

While particular dimensions are indicated on the figures, these dimensions are merely exemplary and adapters according to embodiments of the present invention may be formed in various sizes.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A method for forming a connection, the method comprising:
mounting an adapter on a non-solvent weldable tubing; and
solvent welding the adapter to a solvent weldable member to form a connection between the non-solvent weldable tubing and the solvent weldable member.

2. The method of claim 1 wherein the solvent weldable member is a solvent weldable fitting or solvent weldable tubing.

3. The method of claim 1 wherein the connection formed is a permanent connection between the non-solvent weldable tubing and the solvent weldable member.

4. The method of claim 1 wherein:
the adapter includes a solvent weldable body and a gripper member, the gripper member including a plurality of teeth; and
mounting the adapter on the non-solvent weldable tubing includes mechanically securing the adapter to the non-solvent weldable tubing by engaging the teeth with an outer surface of the non-solvent weldable tubing.

5. The method of claim 4 wherein the gripper member is formed of metal.

6. The method of claim 4 wherein the adapter further includes a support member positioned and configured to limit deflection of the teeth of the gripper member.

7. The method of claim 4 wherein the adapter further includes a resilient seal member.

8. The method of claim 7 wherein the resilient seal member is an elastomeric O-ring.

9. The method of claim 7 wherein the adapter has an inlet end and an outlet end and the seal member is located between the inlet end and the gripper member.

10. The method of claim 9 wherein the teeth are angled away from seal member.

11. The method of claim 4 wherein the adapter has an inlet end and an outlet end and further includes:
a support member positioned between the inlet end and the gripper member and configured to limit deflection of the teeth of the gripper member; and
an elastomeric O-ring located between the inlet end and the gripper member, wherein the teeth are angled away from the O-ring.

12. The method of claim 4 wherein the gripper member is mounted on an exterior portion of the body.

13. The method of claim 1 wherein mounting the adapter on the non-solvent weldable tubing includes:
mounting the adapter in an installation tool; and
inserting the non-solvent weldable tubing through a passage of the adapter while the adapter is mounted in the installation tool.

14. The method of claim 13 wherein:
the adapter includes a solvent weldable body and a gripper member, the gripper member including a plurality of teeth, the teeth being configured to secure the adapter to the non-solvent weldable tubing by engaging the teeth with an outer surface of the non-solvent weldable tubing; and
the step of inserting the non-solvent weldable tubing through the passage of the adapter includes deflecting the teeth into receiving slots in installation tool.

15. An adapter for forming a connection between a non-solvent weldable tubing and a solvent weldable member, the adapter comprising:
a solvent weldable body;
a gripper member mounted on the body, the gripper member being configured to engage and mechanically secure the non-solvent weldable tubing to the adapter; and
a resilient seal member configured to engage and form a fluid-tight seal between the non-solvent weldable tubing and the adapter.

16. The adapter of claim 15 wherein the gripper member includes a ring having a plurality of teeth configured to engage and mechanically secure the non-solvent weldable tubing to the adapter.

17. The adapter of claim 16 wherein the gripper member is formed of metal.

18. The adapter of claim 16 wherein the resilient seal member is an elastomeric O-ring.

19. The adapter of claim 16 wherein the adapter further includes a support member positioned and configured to limit deflection of the teeth of the gripper member.

20. The adapter of claim 16 wherein the adapter has an inlet end and an outlet end and the seal member is located between the inlet end and the gripper member.

21. The adapter of claim 20 wherein the teeth are angled away from seal member.

22. The adapter of claim 16 wherein the adapter has an inlet end and an outlet end and further includes:
a support member positioned between the inlet end and the gripper member and configured to limit deflection of the teeth of the gripper member; and
an elastomeric O-ring located between the inlet end and the gripper member, wherein the teeth are angled away from seal member.

23. The adapter of claim 16 wherein the gripper member is mounted on an exterior portion of the body.

24. An installation tool for use with an adapter for forming a connection between a non-solvent weldable tubing and a solvent weldable member, the adapter including a solvent weldable body and a gripper member mounted on the body, the gripper member including a plurality of teeth configured to engage and mechanically secure the non-solvent weldable tubing to the adapter, the tool comprising:
a receiver portion defining a receiver cavity;
a ledge in the receiver cavity, wherein the ledge is configured to limit insertion of the adapter into the receiver cavity; and
a plurality of slots defined in the ledge;
wherein the slots are configured to receive the teeth of the gripper member when the teeth are deflected by insertion of the non-solvent weldable tubing into the adapter when the adapter is mounted in the receiver cavity.

25. The tool of claim 24 further including a pusher structure configured to receive and engage the adapter when the adapter is mounted on the non-solvent weldable tubing to enable an operator to force the adapter into the solvent weldable member without displacing the non-solvent weldable tubing with respect to the adapter.

26. The method of claim 12 wherein:
the gripper member includes an annular base section having at least one mounting slot defined therein;
the plurality of teeth are integral with and deflectably cantilevered from the base section;
the body includes at least one tab extending from the exterior portion of the body; and
the at least one tab interlocks with the at least one mounting slot to secure the gripper member to the body.

27. The adapter of claim 23 wherein:
the gripper member includes an annular base section having at least one mounting slot defined therein;
the plurality of teeth are integral with and deflectably cantilevered from the base section;
the body includes at least one tab extending from the exterior portion of the body; and
the at least one tab interlocks with the at least one mounting slot to secure the gripper member to the body.

28. A plumbing connection assembly for forming a connection with tubing, the assembly comprising:
a plumbing component body having an exterior portion and at least one tab extending from the exterior portion of the body; and
a gripper member mounted on the plumbing component body, the gripper member comprising:
an annular base section having at least one mounting slot defined therein; and
a plurality of teeth integral with and deflectably cantilevered from the base section, the plurality of teeth being configured to engage and mechanically secure the tubing to the plumbing connection assembly;
wherein the at least one tab interlocks with the at least one mounting slot to secure the gripper member to the body.
